(19) United States
(12) Patent Application Publication
(10) Pub. No.: US 2009/0089623 A1
(43) Pub. Date: Apr. 2, 2009

(54) EVENT TIMING ANALYZER FOR A SYSTEM OF INSTRUMENTS AND METHOD OF ANALYZING EVENT TIMING IN A SYSTEM OF INTRUMENTS

(75) Inventors: Michael J. Neering, Santa Rosa, CA (US); Stanley T. Jefferson, Palo Alto, CA (US); Jefferson B. Burch, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC, Loveland, CO (US)

(21) Appl. No.: 11/863,801

(22) Filed: Sep. 28, 2007

(51) Int. Cl. G06F 11/30

(52) U.S. Cl. 714/39; 714/E11.179

(57) ABSTRACT

An arrangement and method for analyzing the timing of events in a test system including a device under test and a plurality of test instruments connected together by one or more communication connections: time-stamps events in a test routine executed by the test instruments under control of a test program to generate time-stamped event data; communicates the time-stamped event data to a central processor; and processes the time-stamped data to output information about the timing of the events.

### BACKGROUND

When designing and integrating a system of test instruments for performing tests and measurements on a device under test (DUT), it is important to insure that operations of the test instruments are properly timed and coordinated to insure that the test operations perform as expected.

For example, consider the simple case of testing a communication transmitter on several different transmit frequencies with a frequency counter and an RF power meter, all under the control of a test workstation. In such an arrangement, when it is desired to change the transmission channel for the transmitter and make measurements of frequency and power for the new channel, it would be important to insure that the transmission signal is stabilized in frequency and power on the new channel before making the measurements. It would also be necessary to insure that the frequency counter and an RF power meter output signals have stabilized before recording the test data. One can easily see that there are a wide variety of possibly unspecified time delays which must be accounted for in designing the test routine. Such delays include signal propagation delays, set-up times for the test instruments and the transmitter under test, delays for the transmitter to change channels and for its output power to settle/stabilize, etc.

In the past, the test system designer has had limited knowledge and/or control of the timing of these various operations. Furthermore, the test system designer has also had a limited set of tools available to control the sequencing, timing, and synchronization of the operations among the test instruments and DUT. As a result, the designer controls the timing of the operations through a combination of time delays within the instruments, and programmatic delays and interrupts within the test programs controlling the test system.

In general, a test system designer would like more detailed and precise knowledge (and control) of the timing of events in the test system. In many cases, the lack of such information and control may force the test system designer to result to trial-and-error to adjust delays in the system to insure reliable operation and optimize performance. This is particularly problematic when designing a complicated test system, with perhaps dozens of interconnected test instruments, especially when it is desired to minimize test times. As a result, the costs of designing and integrating the test system are increased.

Another particularly troublesome problem may occur when a test system is to be maintained or upgraded and it is either necessary or desirable to replace one or more existing test instruments with newer instruments that have better performance, lower cost, or both. In such a case, it is often the case that the newer instruments operate with different speeds and delays than the “legacy” instruments. When the new instrument(s) are substituted, the timing and coordination of events within the test system may be substantially altered such tat the test system no longer operates properly. So the test system designer has to revise the test program(s) to compensate for the changes in speed and/or delay to restore the system's timing to its prior condition.

However, there is typically very little information available to the designer to understand how the “old” test system configuration timing worked, or what to do to restore the timing to a working arrangement. As noted above, often the designer of the “old” test system may have resorted to trial-and-error to set delays and interrupts for various instruments and in the test program software in the first place. As a result, the designer has few if any attractive options available for replicating the timing conditions of the original test system—and the challenge can be even more difficult in situations where the test software has little documentation of its timing, and/or the original test system designer is no longer available for consultation. Accordingly, the designer typically must resort to experimentally adding and removing delays from the test algorithm by trial-and-error, and/or attempting to analyze the test programs to extract the timing relationships.

The approaches to test system design and maintenance as described above are costly and time-consuming, which in turn can lengthen development times for a test system, and lead to “down time” for the test system when maintenance or upgrades of the test system must be performed. Also, these trial-and-error modifications often degrade the test system performance by increasing test times. These problems are considered to be “facts of life” in test system design and maintenance.

What would be useful, therefore, would be a method for providing better tracking and reporting of the timing and/or sequencing of events in a test system. What would further be useful would be a system for analyzing timing and events in a test system.

### SUMMARY

In an example embodiment, a method is provided for analyzing the timing of events in a test system comprising a device under test and a plurality of test instruments connected together by one or more communication connections. The method comprises: time-stamping events in a test routine executed by the test instruments under control of a test program to generate time-stamped event data; communicating the time-stamped event data to a central processor; and processing the time-stamped data to output information about the timing of the events.

In another example embodiment, an event timing analyzer is provided for a test system comprising a plurality of test instruments connected together by one or more communication connections, and adapted to perform a test routine for a device under test under control of a test program. The event timing analyzer comprises: means for time-stamping events in a test routine to produce time-stamped event data; and means for communicating the time-stamped event data to a central processor.

In yet another example embodiment, an event timing analysis system is provided for a test system comprising a plurality of test instruments connected together by one or more communication connections, and adapted to perform a test routine for a device under test under control of a test program. The event timing analysis system comprises: a communications port adapted to receive event data; and a processor and memory for storing processor instructions to cause the processor to process the event data and to output information about the timing of the events.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIGS. 1A-C are functional block diagrams illustrating various embodiments of a test system including an event timing analyzer.

FIG. 2 illustrates one embodiment of an event monitor.

FIG. 3 is a functional block diagram illustrating another embodiment of a test system including an event timing analyzer.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

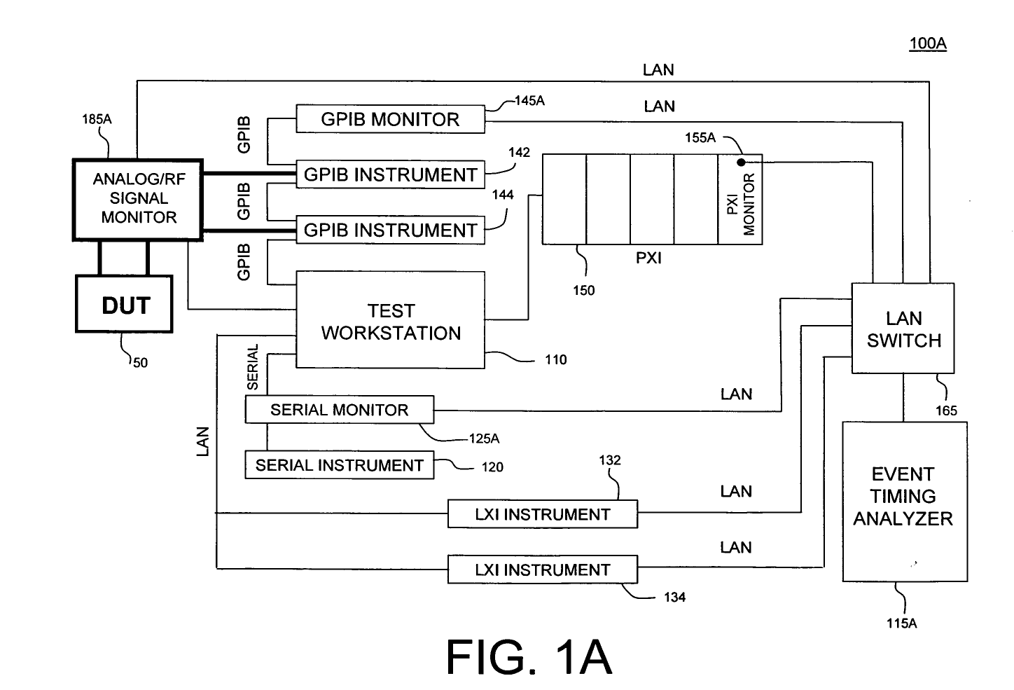

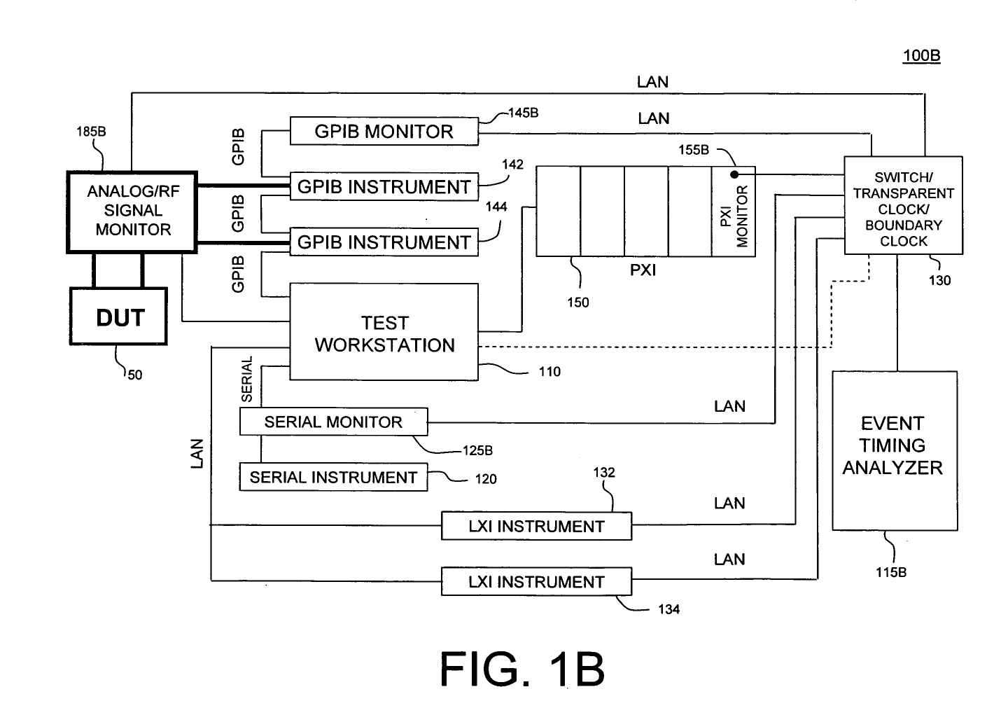

FIG. 1A illustrates one embodiment of a test system 100A including an event and timing analyzer 115A. The system 100A includes a test workstation 110 and a plurality of instruments connected to test workstation 110 for testing a device under test 50. Test instruments in system 100A include serial instrument 120, local area network (LAN) extension for instruments (LXI) instruments 132 and 134, general purpose instrument bus (GPIB) instruments 142 and 144, and compact PCI bus for instrumentation (PXI) instrument 150, all connected to each other, test workstation 110, and/or DUT 50 by corresponding communication, analog and digital connections. LXI instruments 132/134 are also connected to test workstation 110. Although not specifically illustrated in FIG. 1, other types of instruments may be included, for example, VERSAmodule Eurocard (VME) extensions for instrumentation (VXI) instruments.

Of benefit, test system 100A further includes an event timing analysis system comprising event and timing analyzer 115A and a plurality of monitoring devices connected to various communication connections utilized by test system 100. Monitoring devices include serial bus monitor 125A, GPIB monitor 145A, and PXI monitor 155A. A LAN connects these monitoring devices via LAN switch 165 to event and timing analyzer 115A. Monitoring devices 125A, 145A and 155A monitor the occurrence of events of interest on the buses and interfaces to which they are connected.

In the arrangement of FIG. 1A, DUT 50 receives and/or transmits analog and/or digital and/or RF/microwave signals to and/or from GPIB instruments 142/144 via an analog/digital/RF signal monitor 185A. For example, GPIB instrument 142 may be an RF signal generator supplying an RF input test signal to DUT 50, and GPIB instrument 144 may be an RF spectrum analyzer receiving an RF output test signal from DUT 50. Of course this is only one exemplary arrangement. Also, it is to be understood that although not explicitly shown in FIG. 1A for simplification of the drawing, any or all of the test instruments in test system 100A may be connected directly to DUT 50 to transmit and/or receive signals to/from DUT 50, and any appropriate monitoring devices may be included to monitor these connections. Furthermore, although illustrated schematically as a “serial arrangement” it should be understood that analog/digital/RF signal monitor 185A may not be provided as a series connection between DUT 50 and various test instruments, but instead analog/digital/RF signal monitor 185A may include probes, such as capacitive probes, that detect signals passing directly between DUT 50 and the various test instruments.

Although the functional block diagram of FIG. 1A illustrates a plurality of monitoring devices, it should be understood that the functionality of serial bus monitor 125A, GPIB monitor 145A, PXI monitor 155A, and/or analog/digital/RF signal monitor 185A can be combined into a single event monitor with a plurality of inputs and/or outputs for each corresponding monitored communication connection in FIG. 1A. In such a case, the event monitor may be combined with event and timing analyzer 115A. Various physical realizations of the functional blocks of FIG. 1A are possible.

Events of interest that may be detected by the monitoring devices include: traffic on a GPIB bus or a USB bus; traffic on a LAN (e.g., a packet containing an LXI LAN trigger); traffic on a VXI or PXI backplane; traffic on a standard serial or parallel port; signal events occurring on an analog, RF, optical or digital communication path; transitions on an LXI wired trigger bus; transitions on instrument-specific input/output trigger lines. Of course this list is meant to be exemplary, not exhaustive, and so other types of events may also be detected.

In test system 100A, some or all of serial bus monitor 125A, GPIB monitor 145A, PXI monitor 155A, and/or analog/digital/RF signal monitor 185A may operate using a system clock provided by test workstation 110 or event and timing analyzer 115A. In that case, the monitoring device detects an event occurring on its connected bus with the resolution of a clock period of the system clock, and sends the indication of the event's occurrence to event and timing analyzer 115A for time-stamping and further processing as will be discussed in further detail below. As shown in FIG. 1A, the event data may be communicated to event and timing analyzer 115A over a LAN. In that case, it is possible that event timing analyzer 115A will time-stamp the events itself.

However, in the embodiment described above, the events are detected and time-stamped with limited resolution, because they are all controlled by the system clock. Furthermore, delays and timing jitter in this communication path can adversely impact the resulting timestamp.

Accordingly, to address these limitations, FIG. 1B shows another embodiment of a test system 100B including an event and timing analyzer 115B. Test system 100B is similar to test system 100A of FIG. 1A, except that monitoring devices 125B, 145B, 155B and 185B in FIG. 1B share a common time base, and detect and time-stamp events according to that shared common time. Thus events detected by monitoring devices 125B, 145B, 155B and 185B can be ordered by their occurrence in time. It is possible that because of the time resolution of some monitoring devices that the time-stamped order of events is not the actual order of events (or two events may have the same time-stamp). However, even in these cases, event proximity in time still provides useful information for processing by event and timing analyzer 115B, as will be explained in greater detail below. In one embodiment, the analysis component consists primarily of software running on a workstation. The software collects all of the events acquired by all of the monitoring devices. The analysis software sorts all of the events as described in greater detail below. Furthermore, in contrast to test system 100A, when the events are time-stamped at the monitoring device in test system 100B as part of the detection function, communication delays and jitter when sending the events to the event and timing analyzer 115B do not impact the analysis.

In one embodiment, one or all of the monitoring devices of test system 100B include hardware, software and/or firmware to allow operation according to the IEEE-1588 precision time protocol as specified in “IEEE 1588-2002 Standard,” the contents of which are incorporated herein by reference, With IEEE-1588-enabled monitoring devices, the event timing analysis system including an event and timing analyzer 115B can observe and report on events detected in the communication connections of test system 100B with greater detail and accuracy.

In this embodiment, the event timing analysis system including event and timing analyzer 115B and the IEEE-1588 enabled monitoring devices may operate as follows. Each monitoring device monitors events, time-stamps the events using a commonly-distributed IEEE-1588 timebase, and stores the time-stamped event data in a buffer. The monitoring devices are connected to event and timing analyzer 115B via switch boundary clock 130. Switch boundary clock 130 participates in the IEEE-1588 synchronization protocol so that timing delays and jitter in the normal LAN switching process do not adversely impact synchronization across the monitoring devices. In another embodiment, switch boundary clock 130 may be replaced by a transparent clock as defined in IEEE-1588, version 2.

It would also be beneficial in system 100B to provide software modifications or “hooks” in a test program executed by test workstation 110. As an executing thread passes a monitoring point, it would log an event and attach a time-stamp. In a beneficial arrangement, acquired events are time-stamped and buffered for later transmission to analysis software running on event and timing analyzer 115B.

In another arrangement, test workstation 110 may have a time-based mechanism such as a built-in IEEE-1588 capability. For example, an adapter card (e.g., a PCI-based card) in test workstation 110 may implement a commonly distributed time-base mechanism such as IEEE-1588, and this is used to generate the time-stamps. In that case, as shown in FIG. 1B using dashed lines, test workstation 110 is also connected to switch boundary clock 130.

In test system 100A of FIG. 1A, the monitoring devices don't share a common sense of time and only report the events of interest to timing and event analyzer 115A where they are time-stamped. In contrast, in test system 100B of FIG. 1B, the monitoring devices share a common time base (e.g., via the IEEE-1588 protocol) and time-stamp the events of interest before sending the information to timing and event analyzer 115B. However, it is also possible to have a “hybrid” case where some of the monitoring devices operate without a common sense of time, as in test system 100A, and other monitoring devices are synchronized and time-stamp event locally as in test system 100B.

FIG. 1C illustrates a test system 100C that may be considered to be a “hybrid” of test systems 100A and 100B. Test system 100C includes monitoring devices 145B, 155B and 185B which share a common time base and which each time-stamp event data according to that common time. Monitoring devices 145B, 155B and 185B are connected to timing and event analyzer 115C via switch boundary clock 130 (which may be replaced with a transparent clock, as discussed above). Test system 100C further includes serial monitor 125A that does not share the common time base and which sends event data to timing and event analyzer 115C to be time-stamped by timing and event analyzer 115C.

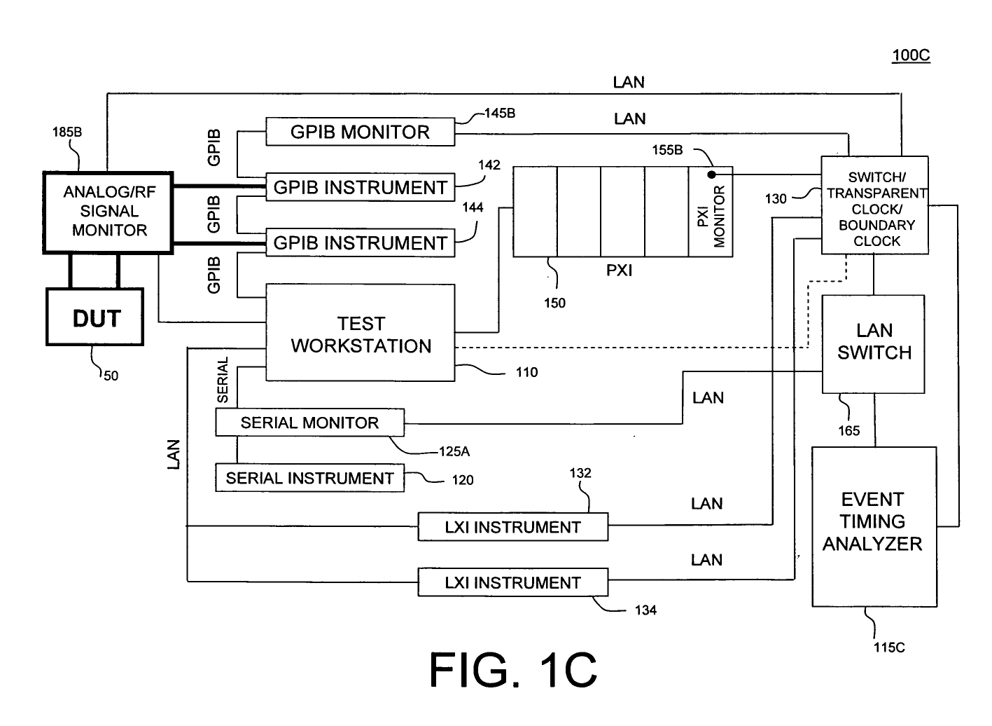

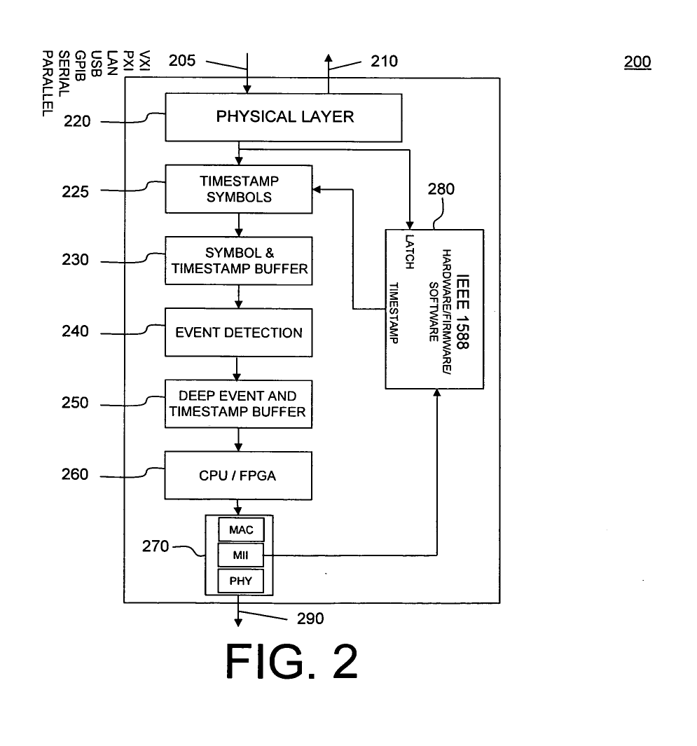

FIG. 2 illustrates one embodiment of a monitoring device 200 that can be employed in any of the test systems 100A, 100B and 100C. Monitoring device 200 includes one or more monitor input ports 205, one or more monitor mirror ports 210, a physical layer interface 220, a time-stamp block 225, a symbol and time-stamp buffer 230, an event detector 240, an event data and time-stamp buffer 250, a data processor 260, a LAN interface 270, a processor 280, and a LAN output 290.

Monitoring device 200 may monitor one communication connection (e.g., the GPIB bus) of test system 100, and accordingly test systems 100A, 100B and 100C may include a plurality of monitoring devices 200. Alternatively, monitoring device 200 may be an event monitor for a plurality of communication connections, including some or all of a serial bus (including USB), a parallel bus, a GPIB bus, a VXI or PXI backplane, a LAN, an analog connection, an RF or microwave connection, an optical connection, an LXI wired trigger bus, an instrument-specific input/output trigger line, etc.

The embodiment of a monitoring device 200 shown in FIG. 2 may operate as follows.

A signal on a communication connection (e.g., on a bus, on a LAN, at input or output connector; etc.) of test system 100A, 100B or 100C is monitored via monitor input port 205. The signal is mirrored onto mirror output port 210 so it can be processed by test system 100 as intended. That can be referred to as passive or pass-through monitoring.

The physical layer 220 outputs digital “symbols” that are time-stamped in time-stamp block 225. In one embodiment, processor 280 is IEEE-1588 precision time protocol hardware for outputting a timestamp corresponding to an edge on a latch input received from physical layer interface 220. Time-stamp buffer 230 buffers the symbols and corresponding time-stamps. Event detector 240 analyzes sequences of symbols for events; for example event detector 240 might detect a sequence of symbols/characters such as “reset” in a bus monitoring application. Event detector 240 could be a pattern matcher or a programmable machine (e.g. finite state machine). Event detector 240 can be used to filter out irrelevant symbols and events. Matched sequences are formed into events with an associated time-stamp and placed into event data and time-stamp buffer 250. When monitoring is complete data processor 260 implements transactions for forwarding the time-stamped event data to an event timing analyzer—for example, event timing analyzer 115A, 115B, or 115C of FIGS. 1A-C. For example, in one embodiment, the time-stamped event data is forwarded from monitoring device 200 to event timing analyzer 115B or 115C over a LAN.

An explanation of operations of event timing analyzers 115A-115C will now be provided.

In one embodiment, event timing analyzers 115A-115C each include software running on a general purpose processor. The software collects all of the events acquired by all of the monitoring devices and sorts all of the events for further processing. In one embodiment, the analysis software includes a graphical user interface (GUI) component that may provide a rich graphical interface to a user. Event timing analyzers 115A-115C may provide one or all of the following capabilities to a user.

The ability to display events in a natural manner depending on their type.

The ability to zoom in and out of segments of time.

The ability to display events on a time line.

The ability to filter events.

The ability to search for events or combinations of events.

The ability to group and label combinations of events.

The ability to treat a combination or sequence of events as a single named unit.

The ability to open and inspect the events comprising the unit in detail.

The ability to annotate events or groups of events with additional information (comments, graphs, pictures, tables of data, etcetera).

The ability to apply formulas, expressions, or software programs to groups of event data to form synthesized data or events. For example a current measurement and voltage measurement could be used to compute a power measurement, which could be associated with time. Graphical data (e.g. charts) could also be computed and displayed using this capability.

The ability to display intervals during which information is valid in addition to discrete points in time.

The ability to perform a statistical analysis of repeating cycles of events.

The ability to automatically find of the beginning and ending of a cycle.

The ability to merge cycles from different monitoring trials.

The ability to find and display outliers (e.g. trigger jitter relative to a fixed event in a cycle).

The ability to perform automated mean, standard deviation, minimum and/or maximum, analyses for the relative time between two events.

The ability to output a schedule(s) or computer program(s) that can be used to emulate the timing of a legacy system. The schedules or programs would be used with instruments having a common time-base (e.g. IEEE-1588) that could be used to schedule events (e.g. LXI triggers, events, etc.).

The statistical analysis of cycles is useful both in analyzing legacy test systems that are being converted to time-based systems, and also in determining the performance of new time-based systems. Even new time-based systems will have time variability in them due to the presence of non-deterministic elements such as computers and LAN, and determining the timing envelope will allow explicitly timed actions to be adjusted to make for a more robust system.

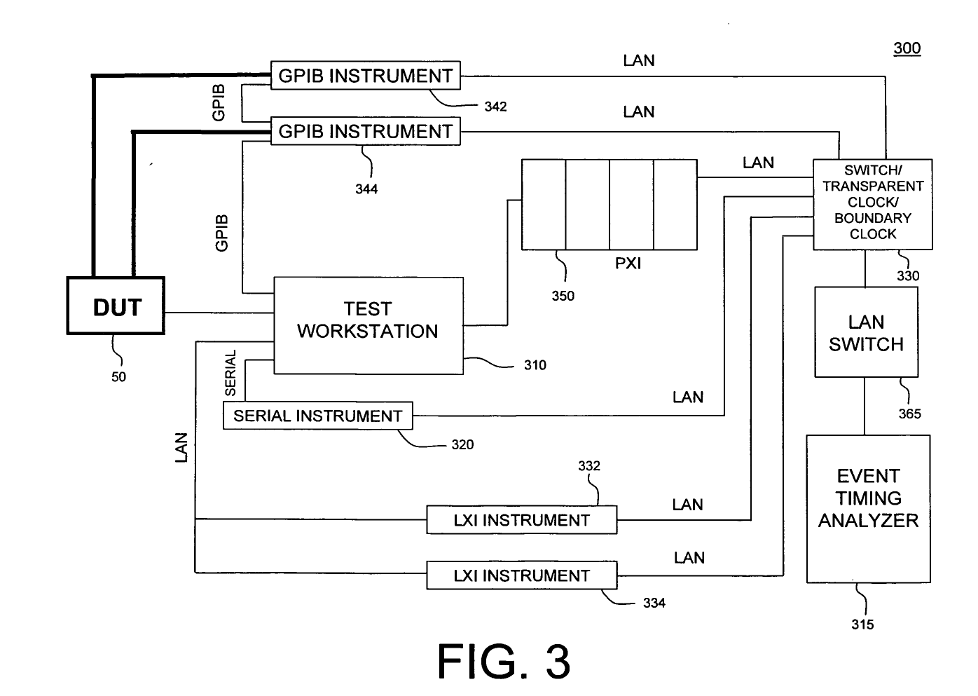

FIG. 3 is a functional block diagram illustrating a test system including another embodiment of an event timing analyzer. The system 300 includes a test workstation 310 and a plurality of instruments connected to test workstation 310 for testing a device under test (50). Test instruments in system 300 include serial instrument 320, local area network (LAN) extension for instruments (LXI) instruments 332 and 334, general purpose instrument bus (GPIB) instruments 342 and 344, and compact PCI bus for instrumentation (PXI) instrument 350, all connected to each other, test workstation 310, and/or DUT 50 by corresponding communication connections. LXI instruments 332/334 are connected to test workstation 310 via a switch/boundary clock 330. Although not specifically illustrated in FIG. 5, other types of instruments may be included, for example, VERSAmodule Eurocard (VME) extensions for instrumentation (VXI) instruments.

In the arrangement of FIG. 3, DUT 50 receives and/or transmits analog and/or RF/microwave signals to and/or from GPIB instruments 342/344. For example, GPIB instrument 342 may be an RF signal generator supplying an RF input test signal to DUT 50, and GPIB instrument 344 may be an RF spectrum analyzer receiving an RF output test signal from DUT 50. Of course this is only one exemplary arrangement, and it is understood that although explicitly shown in FIG. 3, any or all of the test instruments in test system 300 may be connected directly to DUT 50 to transmit and/or receive signals to/from DUT 50.

In test system 300 the instruments 320, 332, 334, 342, 344, and 350 themselves all maintain a common precision time. For example, instruments 320, 332, 334, 342, 344, and 350 may all be IEEE-1588 enabled devices which all maintain a common precision time according to the IEEE-1588 protocol.

Of benefit, in the embodiment of FIG. 3, each instrument 320, 332, 334, 344 and 350 has built-in monitoring capability implemented in a combination of hardware, firmware, and software Each of the instruments 320, 332, 334, 342, 344, and 350 is further adapted to use its 1588-compliant precision clock to time-stamp events of interest that are detected internally and/or on its input/output connections. Test system 300 further includes an event and timing analyzer 315. Each instrument generates time-stamped event data and forwards the time-stamped event data to event and timing analyzer 315—for example, over a LAN.

Event and timing analyzer 315 may process event data as explained above with respect to timing analyzers 115A-115C of FIGS. 1A-1C.

In similarity to test systems 100A-100C in FIGS. 1A-1C, it would also be beneficial in system 300 to provide software modifications or “hooks” in a test program executed by test workstation 310. As an executing thread passes a monitoring point, it would log an event and attach a time-stamp. In a beneficial arrangement, acquired events are time-stamped and buffered for later transmission to analysis software running on event and timing analyzer 315.

In some embodiments, monitoring devices described above (including test instruments, standalone monitoring devices, and/or event analyzer workstations) are able to store additional state and measurement variables present in the monitoring device along with the detected event. This is particularly useful in the case where the monitoring device is a test instrument, for example, in the case of a digital multimeter (DMM), one might want the voltage measurements and/or state of the instrument when capturing and time-stamping the event to read the voltage.

While example embodiments are disclosed herein, one of ordinary skill in the art appreciates that many variations that are in accordance with the present teachings are possible and remain within the scope of the appended claims. The embodiments therefore are not to be restricted except within the scope of the appended claims.

1. A method for analyzing the timing of events in a test system comprising a device under test and a plurality of test instruments connected together by one or more communication connections, the method comprising:
time-stamping events in a test routine executed by the test instruments under control of a test program, to generate time-stamped event data;
communicating the time-stamped event data to a central processor; and
processing the time-stamped data to output information about the timing of the events.

2. The method of claim 1, wherein time-stamping the events in the test routine comprises:
providing a monitoring device to monitor at least one of the one or more communication connections,
the monitoring device detecting occurrence of the events via the monitored communication bus;
communicating an indication that the event occurred from the monitoring device to a processor; and
the processor recording the time of the event.

3. The method of claim 2, wherein time-stamping the events in the test routine further comprises:
providing a second monitoring device to monitor at least a second one of the one or more communication connections, the second monitoring device having a time clock synchronized with a common time base;
the second monitoring device detecting occurrence of the events via the second monitored communication bus; and
the second monitoring device time-stamping detected events.

4. The method of claim 1, wherein time-stamping the events in the test routine comprises:
providing a monitoring device to monitor at least one of the one or more communication connections, the monitoring device having a time clock synchronized with a common time base;
the monitoring device detecting occurrence of the events via the monitored communication bus; and
the monitoring device time-stamping detected events.

5. The method of claim 4, wherein communicating the time-stamped event data to a central processor comprises communicating from the monitoring device to the central processor an indication of the detected events and the associated time-stamps.

6. The method of claim 4, wherein time-stamping the events in the test routine further comprises:
providing a second monitoring device to monitor at least one of the one or more communication connections, the second monitoring device having a time clock synchronized with the common time base;
the second monitoring device detecting occurrence of the events via the second monitored communication bus; and
the second monitoring device time-stamping detected events,
wherein the first and second monitoring devices synchronize their clocks according to an IEEE-1588 protocol.

7. The method of claim 1, wherein the events comprise data on at least one of a GPIB bus, a local area network, a universal serial bus, an RS-232 port, an IEEE-1284 port, and a FireWire port.

8. The method of claim 1, wherein the events comprise data on at least one of a transition on an LXI trigger bus and a trigger input port for one of the test instruments.

9. The method of claim 1, wherein the events comprise signals occurring on an analog, optical, or RF signal path in the test system.

10. The method of claim 1, wherein the events comprise events that occur internal to a single test instrument.

11. The method of claim 1, wherein time-stamping the events in the test routine includes time-stamping events within individual test instruments.

12. An event timing analysis system for a test system comprising a plurality of test instruments connected together by one or more communication connections, and adapted to perform a test routine for a device under test under control of a test program, the event timing analysis system comprising:
means for time-stamping events in a test routine to produce time-stamped event data; and
means for communicating the time-stamped event data to a central processor.

13. The event timing analysis system of claim 12, wherein the means for time-stamping the events comprises a first monitoring device adapted to monitor at least a first one of the one or more communication connections.

14. The event timing analysis system of claim 13, wherein the first monitoring device includes a time clock, and wherein the means for time-stamping the events further comprises a second monitoring device including a time clock synchronized with the time clock of the first monitoring device, wherein the first and second monitoring devices synchronize their clocks according to an IEEE-1588 protocol.

15. The event timing analysis system of claim 14, wherein the first monitoring device and the second monitoring device are adapted to synchronize their time clocks according to an IEEE 1588 protocol.

16. The event timing analysis system of claim 12, wherein the means for time-stamping events in a test routine time-stamps events within a test instrument, and the means for communicating the time-stamped event data to a central processor comprises a communication bus connecting the test instrument to the central processor, wherein the test instrument communicates the time stamped information to the central processor via the communication bus.

17. The event timing analysis system of claim 12, further comprising the central processor, wherein the central processor is adapted to operate under software control for processing the time-stamped data to output information about the timing of the events.

18. The event timing analysis system of claim 17, wherein the central processor comprises the means for time-stamping the events.

19. An event timing analyzer for a test system comprising a plurality of test instruments connected together by one or more communication connections, and adapted to perform a test routine for a device under test under control of a test program, the event timing analyzer comprising:
a communications port adapted to receive event data; and
a processor and memory for storing processor instructions to cause the processor to process the event data and to output information about the timing of the events.

20. The event timing analyzer of claim 19, wherein the communications port is adapted to receive time-stamped event data, and wherein the processor and memory are configured to store the time-stamped event data.

21. The event timing analyzer of claim 19, further comprising a system clock, wherein the processor and memory are configured to time-stamp the event data using the system clock.

22. A method for analyzing the timing of a test sequence in a first test system comprising a device under test and a plurality of test instruments connected together by one or more communication connections, the method comprising:
providing one or more monitoring devices to monitor at least one of the one or more communication connections;
time-stamping events in a test sequence executed by the test instruments under control of a test program, to generate time-stamped event data;
communicating the time-stamped event data to a central processor; and
processing the time-stamped data to characterize timing of events in the test sequence in the first test system.

23. The method of claim 22, further comprising replacing at least one test instrument or communication bus in the first test system such that the timing of events in the test sequence does not change.

24. The method of claim 22, further comprising:
constructing a second test system comprising the device under test, and a second plurality of test instruments different than the test instruments in the first test system, connected together by one or more second communication connections different than the communication connections in the first test system; and
executing the test sequence with the second test system,
wherein a timing of events in the test sequence executed by the second test system is the same as the timing of events in the test sequence executed by the first test system.

25. The method of claim 22, further comprising indicating the occurrence of the events to a user via a user interface, and allowing the user to manipulate the display of the vents in the user interface.
